(19) United States
(12) Patent Application Publication
(10) Pub. No.: US 2012/0103912 A1
(43) Pub. Date: May 3, 2012

(54) MIXED VALENCY METAL SULFIDE SORBENTS FOR HEAVY METALS

(75) Inventors: Lucy Jane Hetherington, Faceby (GB); Matthew John Cousins, Darlington (GB)

(73) Assignee: JOHNSON MATTHEY PLC, London (GB)

(21) Appl. No.: 13/145,682

(22) PCT Filed: Jan. 14, 2010
(86) PCT No.: PCT/GB2010/050042

§ 371 Date: Oct. 3, 2011

(30) Foreign Application Priority Data
Jan. 21, 2009 (GB) 0900965.5

(51) Int. Cl. B01J 20/02; C01G 37/00; C01G 45/00; C01G 49/12; C01G 51/00; B01D 53/02; B01J 20/10; B01J 20/08; B01J 20/28; B01J 20/30; B01J 20/32; B01D 15/04; C01G 31/00; C01G 53/11

(52) U.S. Cl. 210/688; 423/561.1; 502/400; 502/406; 502/74; 502/80; 502/415; 95/134

(57) ABSTRACT

A sorbent, suitable for removing heavy metals, including mercury, from fluids containing hydrogen and/or carbon monoxide at temperatures up to 550° C., in the form of a shaped unit comprising one or more mixed-valency metal sulphides of vanadium, chromium, manganese, iron, cobalt or nickel.

This invention relates to sorbents suitable for the removal of heavy metals such as mercury from reducing gas streams.

Heavy metals may be found in a number of reductant-containing fluids used or created by industrial processes, particularly those derived from coal, crude oil and some natural gas reserves. Their removal is necessary for the safe and environmentally sound processing of these fluids. For example, emission of heavy metals such as mercury, arsenic, selenium and cadmium from synthesis gases, particularly gases containing hydrogen and carbon oxides derived from coal gasification processes such as Integrated Gasification Combined Cycle (IGCC) processes has become a major environmental concern. Traditional methods for removing mercury, which may exist in either elemental form or as mercuric (i.e. Hg²⁺) compounds, include trapping it in the ash formed by the gasification process or by using additives in the water-wash stages used to cool and purify the gas streams. Alternatively the mercury may be trapped using carbon sorbents at low temperature. Such sorbents are limited in their effectiveness and can release mercury during process excursions.

The presence of hydrogen and/or carbon dioxide in these gas streams poses a further complication. Under the conditions at which it is desirable to remove the heavy metals, traditional metal sulphide sorbents can be unstable. For example copper, nickel, cobalt and iron compounds may be reduced in hydrogen gas streams. This reduction process can render such sorbents unstable and prone to evolve captured mercury.

US2008/0184884 discloses a process for removing mercury from a reducing gas stream containing hydrogen and/or carbon monoxide and at least one of hydrogen sulphide and/or carbonyl sulphide, by contacting the reducing gas stream with a dispersed copper-containing sorbent at a temperature in the range 25-300° C. Whereas the Cu(II) sulphide sorbent formed appears effective under steady-state conditions, it also appears that the sorbent can release the captured mercury under different process conditions.

In view of the variable gas compositions from coal combustion and other processes that produce reducing gas streams, there is a need to provide a high-capacity sorbent for recovering mercury form reducing gas streams that is more stable than the metal sulphide sorbets of the prior art.

Accordingly the invention provides a sorbent in the form of a shaped unit comprising one or more mixed-valency metal sulphides of vanadium, chromium, manganese, iron, cobalt or nickel.

The invention further provides a method for the production of a sorbent in the form of a shaped unit comprising one or more mixed-valency metal sulphides of vanadium, chromium, manganese, iron, cobalt or nickel, comprising the steps of:
(i) reducing a sorbent precursor containing a metal sulphide precursor compound of vanadium, chromium, manganese, iron, cobalt or nickel to a lower oxidation state with a hydrogen containing gas to form a reduced composition, and
(ii) sulphiding the reduced composition with a sulphiding compound to form the sorbent,
wherein the sorbent precursor or sorbent are shaped.

The invention further provides a process for the removal of heavy metals from fluids such as reducing gas streams by contacting the gas stream with the sorbent at a temperature up to 550° C.

By the term “sorbent” we include adsorbent and absorbent.

The term “heavy metals” includes mercury, arsenic, lead, cadmium, antimony, tin, platinum, palladium and gold, but the sorbent of the invention is particularly useful for capturing mercury, arsenic, selenium and cadmium, especially mercury.

The sorbents of the present invention differ from those previously employed by virtue of the mixed valency, which gives rise to sorbents with improved stability under reducing conditions. Accordingly, the sorbents of the present invention are less prone to release mercury during process excursions or during shut-down.

The sorbents comprise one or more mixed-valency metal sulphides of vanadium, chromium, manganese, iron, cobalt or nickel. The presence of mixed valency metal sulphides may be readily determined using X-Ray Diffractometry (XRD). Preferably the mixed valency metal sulphides are selected from CO₃S₄, CO₆S₅, CO₉S₈, V₅S₈, Ni₃S₄ and Ni₃S₂ as these have been found to be more convenient to manufacture. One or more of the mixed-valency metal sulphides may be present in the sorbent. Non-mixed valency, i.e. single valency sulphides, may also be present but this can result in undesirable release of heavy metals. Preferably the sulphide consists essentially of one or more mixed valency metal sulphides, particularly one or more nickel sulphides, especially Ni₃S₂ and/or Ni₃S₄. The nickel sulphide sorbents have been found to have a higher mercury capacity and rate of removal than the other mixed-valency metal sulphide sorbents.

In shaped form, the sorbents desirably comprise a support and/or binder in addition to the mixed valency metal sulphide.

Thus in one embodiment the sorbent comprises a mixed valency metal sulphide of vanadium, chromium, manganese, iron, cobalt or nickel supported on a shaped support. Shaped supports may include monoliths or foams but are preferably pellets, extrudates or granules prepared from a suitable support material, such as an alumina, titania, zirconia, alumino-silicate, metal aluminate, hydrated metal oxide, mixed metal oxide, cement, zeolite or ceramic materials. Metal supports coated with a suitable metal oxide or mixed metal oxide wash coat may also be used. The highly-temperature-stable refractory oxides may be of particular use in preparing sorbents for use in demanding processes. The sorbent precursor may be made by impregnating the shaped support with a suitable solution of the metal sulphide precursor compound such as a metal salt, e.g. nickel nitrate, using known methods. The impregnated support may be dried, reduced and sulphided where the metal compound is readily sulphidable, or the dried material may optionally be calcined to convert the metal compound into the respective oxide and the calcined material then sulphided and reduced to provide the sorbent.

In an alternative embodiment, the sorbent comprises one or more powdered sulphidable vanadium, chromium, manganese, iron, cobalt or nickel containing materials that have been shaped with the aid of a binder, reduced and sulphided. The shaped sorbent thereby comprises one or more mixed valency metal sulphides and a binder. Binders that may be used to prepare the shaped units include clays such as Minugel and Attapulgite clays, cements, particularly calcium aluminate cements such as ciment fondu, and organic polymer binders such as cellulose binders, or a mixture thereof. Particularly strong shaped units may be formed where the binder is a combination of a cement such as a calcium aluminate and an aluminosilicate clay having an aspect ratio >2, such as an Attapulgite clay. In such materials, the relative amounts of the cement and clay binders may be in the range 1:1 to 3:1 (first to second binder). The total amount of the binder may be in the range 1-20% by weight, preferably 1-10% by weight (based upon the sulphided composition).

In an alternative embodiment, the sorbent comprises one or more powdered vanadium, chromium, manganese, iron, cobalt or nickel-containing materials that have been combined with a powdered support material and shaped with the aid of a binder, then dried, reduced and sulphided. The shaped sorbent thereby comprises one or more mixed valency metal sulphides, a support material and a binder. The support may be any inert support material suitable for use in preparing sorbents. Such support materials are known and include alumina, metal-aluminate, silica, titania, zirconia, zinc oxide, aluminosilicates, zeolites, metal carbonate, carbon, or a mixture thereof. Support materials are desirably oxide materials such as aluminas, titanias, zirconias, silicas and aluminosilicates. Hydrated oxides may also be used, for example boehmite or alumina trihydrate. Preferred supports are hydrated aluminas or transition aluminas such as gamma, theta and delta alumina. The support may be present in an amount 25-90% wt, preferably 70-80% wt (based upon on the sulphided composition).

The sorbent is in shaped form, either as a monolith, honeycomb or foam or shaped units such as pellets, extrudates or granules. The pellets, extrudates or granules preferably have a minimum dimension (i.e. width or length) in the range 1 to 15 mm and a maximum dimension in the range 1 to 25 mm, with an aspect ratio (longest dimension divided by shortest dimension) ≦4. Shaped supports such as cylinders, spheres, lobed or fluted extrudates or pellets may be used. Trilobal extrudates are particularly preferred. For granulated products, spherical granules with a diameter in the range 1-15 mm are preferred.

The method for making the sorbents of the present invention may comprise the steps of: (i) reducing a sorbent precursor containing a metal sulphide precursor compound of vanadium, chromium, manganese, iron, cobalt or nickel, and optionally a support or binder, to a lower oxidation state with a hydrogen containing gas to form a reduced composition, and (ii) sulphiding the reduced composition with a sulphiding compound to form the sorbent. The support, sorbent precursor or sorbent itself may be shaped.

Suitable metal sulphide precursor compounds may be sourced commercially or synthesised using known methods and include the water-soluble salts, particularly the metal nitrates, the oxides, hydroxides, carbonates or hydroxycarbonates of the metals.

It is preferred that the metal sulphide precursor compound is supported and then this supported sorbent precursor material subsequently reduced and sulphided.

In one embodiment, the sorbent precursor may be made by impregnating a support material, which may be in the form of a powder, monolith, honeycomb, foam or shaped unit such as a tablet, extrudate or granule, with a solution of a soluble salt of vanadium, chromium, manganese, iron, cobalt or nickel, followed by drying the impregnated support. Suitable soluble salts include the nitrates, acetates and hexa-amine salts. If desired, the dried material may be calcined to convert the salt to the respective oxide prior to the reduction and sulphiding steps.

Alternatively, the sorbent precursor may be made by mixing a powdered metal sulphide precursor compound such as an oxide, hydroxide, carbonate or hydroxycarbonate of vanadium, chromium, manganese, iron, cobalt or nickel, with a powdered support material and/or one or more binders. Again, the metal sulphide precursor compound may be commercially sourced or may be generated using known methods, e.g. by precipitation from a solution of metal salts using alkaline precipitants, such as an alkali metal carbonate and/or alkali metal hydroxide, using known methods, followed by drying and optionally calcination.

The sulphiding step may be carried out sequentially after the reduction or the reduction and sulphiding steps may be carried out simultaneously. Improved results, particularly for the Ni sorbents, are obtained when the sulphiding step is carried out after the reduction step.

Where the sorbent precursor is in the form of a powder it may be shaped prior to reduction and sulphidation. Alternatively the material may be shaped after reduction but before sulphidation or the reduced and sulphided material, i.e. the sorbent, may be shaped. It has been found preferable to use shaped supports or to shape the sorbent precursor composition prior to reduction and sulphidation.

Where the support is shaped, then the sorbent precursor and sorbent require no shaping step.

Where the sorbent precursor is a powder, sorbent precursor tablets may be formed by moulding a powder composition, generally containing a material such as graphite or magnesium stearate as a moulding aid, in suitably sized moulds, e.g. as in conventional tableting operation. Alternatively, the sorbent precursor may be in the form of extruded pellets formed by forcing a suitable composition and often a little water and/or a moulding aid as indicated above, through a die followed by cutting the material emerging from the die into short lengths. For example extruded pellets may be made using a pellet mill of the type used for pelleting animal feedstuffs, wherein the mixture to be pelleted is charged to a rotating perforate cylinder through the perforations of which the mixture is forced by a bar or roller within the cylinder: the resulting extruded mixture is cut from the surface of the rotating cylinder by a doctor knife positioned to give extruded pellets of the desired length. Alternatively, the sorbent precursor may be in the form of agglomerates formed by mixing a powder composition with a little water, insufficient to form a slurry, and then causing the composition to agglomerate into roughly spherical, but generally irregular, granules. The different shaping methods have an effect on the surface area, porosity and pore structure within the shaped articles and in turn this often has a significant effect on the sorption characteristics and on the bulk density.

Thus beds of sorbents in the form of moulded tablets may exhibit a relatively broad absorption front, whereas beds of agglomerates can have a much sharper absorption front: this enables a closer approach to be made to the theoretical absorption capacity. On the other hand, agglomerates generally have lower bulk densities than tableted compositions.

The reducing gas stream comprises hydrogen. Pure hydrogen may be used or gas mixtures containing hydrogen such as hydrogen in nitrogen or synthesis gases (mixtures of hydrogen and carbon oxides) may be used. Reduction temperatures in the range 100-700° C. may be used, preferably 150-500° C., particularly 350-450° C. for Ni sorbents.

The sulphur compound used to sulphide the precursor may be one or more sulphur compounds selected from hydrogen sulphide, carbonyl sulphide, mercaptans and polysulphides. Sulphiding gases comprising hydrogen sulphide are preferred. Hydrogen sulphide is preferably provided to the precursor in gas streams at concentrations of 0.1 to 5% by volume. Sulphiding temperatures in the range 20-500° C. may be used, e.g. 100-450° C., particularly 200-300° C. for Ni sorbents.

We have found that the particular combination of reduction at 350-450° C. and sulphidation at 200-300° C. to be especially useful in producing Ni₃S₂.

The present invention may be used to treat both liquid and gaseous fluids containing one or more reductants such as hydrogen and/or carbon monoxide. In one embodiment, the fluid is a liquid hydrocarbon stream containing dissolved hydrogen and/or carbon monoxide. Such liquids are preferably treated with the sorbent at temperatures in the range 0-150° C., preferably 10-100° C. In another embodiment, the fluid is a gaseous stream containing hydrogen and/or carbon monoxide, i.e. a reducing gas stream. Such gases are preferably treated with the sorbent at temperatures in the range 10-550° C.

Fluids which are susceptible to being treated by the sorbents may also include those which inherently contain both heavy metal and a sulphur compound or a heavy metal-containing stream to which a sulphur compound has been added. However the presence of sulphur compounds in the fluid is, unlike the aforesaid US2008/0184884, not essential to the use of the sorbents of the present invention.

In a preferred embodiment, the process is used for the removal of heavy metals, particularly mercury, arsenic selenium and cadmium from reducing gas streams comprising hydrogen and/or carbon monoxide. Such reducing gas streams may be contacted with the sorbent at a temperature up to 550° C., preferably 500° C., more preferably 450° C., without evolution of heavy metal. For example, using mixed valency Co sorbents the invention may be used up to about 470° C. and using Ni sorbents, the invention may be used at temperatures up to about 550° C. Being able to operate at higher temperatures is a distinct advantage over prior art sorbents.

Gas streams that may benefit from this process include synthesis gas streams from conventional steam reforming processes and/or partial oxidation processes, but particularly synthesis gas streams from a coal gasifier, e.g. as part of a IGCC process, before or after gas washing and heat recovery (cooling) steps, and before the sour shift stage. The temperature range in this application may be in the range 200-550° C.

Other streams that may benefit from the present invention include refinery vent streams, refinery cracker streams, blast furnace gases, reducing gases used by the glass industry or steel hardening processes, ethylene-rich streams and liquid or gaseous hydrocarbon streams, e.g. naphtha, fed or recovered from hydrotreating processes, such as hydrodesulphurisation or hydrodenitrification.

In use, the shaped units of sorbent material may be placed in a sorption vessel in the form of a fixed bed and the fluid stream containing heavy metal is passed through it. It is possible to apply the sorbent in the vessel as one or more fixed beds according to known methods. More than one bed may be employed and the beds may be the same or different in composition, e.g. other sorbent technologies may be used in conjunction with this invention such as existing fixed bed sulphur removal technologies. The gas hourly space velocity through the sorbent may be in the range normally employed.

The invention is further illustrated by reference to the following Examples.

### EXAMPLE 1

### Vanadium Sorbents

Spherical granules (37% wt V) were produced in a granulator using the following recipe:

| | | |
|---|---|---|
| Metal sulphide precursor: V₂O₅ (Alfa Aesar) | 1 kg | (70 pts) |
| Alumina trihydrate support | 429 g | (30 pts) |
| Clay binder (Minugel) | 100 g | (7 pts) |

The powders were pre mixed and then granulated by alternate additions of water and powder. The resulting granules were sieved and dried at 105° C. overnight. Because, the sorbent precursor already comprised mixed valency vanadium no reduction step was required. The sorbent precursor granules were sulphided in 1% H₂S/N₂ at 400° C. until saturation (i.e. inlet [H₂S]=exit [H₂S]). The resulting material (1a) was analysed by XRD and shown to consist of V₂O₃ and V₅S₈.

The ability of the 1a sorbent to capture mercury was determined in a liquid phase static test as follows: 60 mls of hexane saturated with elemental mercury was stirred in a conical flask. 0.5 g of the 1a sorbent material was added to the flask and samples of the solution were taken at regular time intervals and analysed for mercury content by atomic fluorescence detection. From the Hg removal over time a 1^{st} order rate may be calculated. After 30 minutes at room temperature the sorbent had removed 36% wt of the mercury. The 1^{st} order rate of removal was determined to be 0.013 s⁻¹.

The ability of the 1a sorbent to capture mercury in the gas phase was compared with that of Norit Activated Carbon (RB3 Grade) in a simple gas phase test as follows: 5 g of each sorbent material was charged to a glass reactor of internal diameter 20 mm. Nitrogen gas containing 10-11 mg/m³ of elemental mercury vapour was passed downwards over the sorbent material at atmospheric pressure and a flow rate of 200 ml/min. The test was left under these conditions for 1950 hours. At the end of the test, the material was purged with clean nitrogen gas before discharging the sorbent material from the reactor. The sorbent materials were analysed for mercury content by acid digestion followed by ICP-OES analysis.

TABLE 1

| Material | Mercury Loading (ppmw) |
|---|---|
| 1a | 11300 |
| Carbon | 550 |

The results clearly show the superior mercury sorbency of material 1a.

### EXAMPLE 2

### Cobalt Sorbents

Spherical granules (48% Co) were produced in a granulator using the following recipe:

| | | |
|---|---|---|
| Metal sulphide precursor Co₃O₄ (Alfa Aesar) | 500 g | (70 pts) |
| Alumina trihydrate support | 214 g | (30 pts) |
| Clay binder (Minugel) | 50 g | (7 pts) |

The powders were pre mixed and then granulated by alternate additions of water and powder. The resulting granules were sieved and dried at 105° C. overnight.

The shaped sorbent precursor granules were reduced and sulphided using the following conditions:

TABLE 2

| | Pre-Reduction | | | Sulphiding | |
|---|---|---|---|---|---|
| Prep Ref. | | Temp. | Time | | Temp. |
| No. | Gas | (° C.) | (h) | Gas | (° C.) |
| 2a | 100% H₂ | 380 | 4 | 1% H₂S in N₂ | 250 |
| 2b | no pre-reduction performed | | | 1% H₂S in H₂ | 250 |
| 2c | 10% H₂ in N₂ | 400 | 45 | 1% H₂S in 10% H₂/N₂ | 400 |

| | | | |
|---|---|---|---|
| 2d | no pre-reduction performed | 1% H₂S in 10% H₂/N₂ | 400 |

In each case, a GHSV of 700⁻¹ was employed and the materials were sulphided to saturation (inlet [H₂S]=exit [H₂S]). The resulting materials were analysed by XRD.

TABLE 3

| Material | Phases present (XRD) | S Content (% w/w) |
|---|---|---|
| 2a | Co₃S₄, Co₉S₈ | 33.4 |
| 2b | Co₆S₅ | 24.81 |
| 2c | Co₆S₅, Co₉S₈ | 32.6 |
| 2d | Co₆S₅, Co₉S₈ | 27.8 |

The stability to hydrogen (reducibility) of the Example 2a granules was determined by heating in 4% H₂/He up to 550° C. with analysis of the evolved gases by mass spectroscopy. The sorbent was stable up to approximately 470° C. at which point it started to produce H₂S.

The ability of two of the cobalt sorbent materials (2a and 2b) was tested for mercury removal in a liquid phase static test according to the method of Example 1. After 30 minutes at room temperature the cobalt sorbent 2a had removed 78% wt of the mercury, while cobalt sorbent 2b had removed 72% wt of the mercury. The 1^{st} order rate constants were determined to be 0.049 s⁻¹ and 0.039 s⁻¹ respectively.

The ability of the cobalt sorbents to remove mercury was also determined using a flowing test whereby 25 ml of the test material was charged to a 19 mm ID glass reactor. n-hexane saturated with elemental mercury (ca 1 ppmw) was then pumped through the bed (upflow) at a given LHSV. Samples of the hexane exiting the reactor were taken regularly and analysed for mercury by atomic fluorescence. The length of each test was 750 hours unless otherwise stated. At the end of the test, the sorbent was dried using a gentle flow of nitrogen, and discharged from the reactor.

Example 2a was tested. Initially a liquid hour space velocity (LHSV) of 7 h⁻¹ was employed but Hg slip exit the bed was observed so the LHSV was reduced to 4 h⁻¹ and then 2 h⁻¹. This reduced the slip to single-figure ppb levels. The material was run for 365 hours at which point the exit mercury slippage started to increase. At this point the test was stopped, the bed dried and the spent sorbent recovered. The cumulative mercury content of the bed was 38.21 mg.

Example 2b was also tested in a simple gas phase test according to the method of Example 1. The resulting mercury loading was compared with that of carbon below.

TABLE 4

| Material | Mercury Loading (ppmw) |
|---|---|
| 2b | 1455 |
| Carbon | 550 |

Again the mixed valency metal sulphide was more effective than carbon.

### EXAMPLE 3

### Nickel Sorbents

The sorbent precursor employed was a commercially available material (“HTC-600” from Johnson Matthey Catalysts) comprising nickel oxide (29.9%% wt Ni) on a 1.2 mm alumina trilobe support. Two reduction and sulphiding experiments were carried out as follows:

TABLE 5

| | Pre-Reduction | | Sulphiding | | |
|---|---|---|---|---|---|
| | | Temp. | Time | | Temp. |
| Precursor | Gas | (° C.) | (h) | Gas | (° C.) |
| 3a | 100% H₂ | 400 | 4 | 1% H₂S in N₂ | 250 |
| 3b | no pre-reduction step | | | 1% H₂S in | 400 |
| | | | | 10% H₂/N₂ | |

In each case, a gas hourly space velocity (GHSV) of 700 h⁻¹ was employed and the materials were sulphided to saturation (inlet [H₂S]=exit [H₂S]). XRD analysis on the samples gave the following:

TABLE 6

| Material | Phases present (XRD) | S Content (% w/w) |
|---|---|---|
| 3a | Ni₃S₄, Ni₃S₂, delta alumina | 5.32 |
| 3b | Ni₃S₄, delta alumina | 4.20 |

The Example 3a Ni₃S₄/Ni₃S₂ material was heated in 4% H₂/He up to 550° C. with analysis of the evolved gases by mass spectroscopy. It was stable up to 550° C. with no evidence of reduction of the sulphide to form H₂S.

Example 3a was tested for mercury removal in a liquid phase static test according to the method of Example 1. After 30 minutes at room temperature, the sorbent removed 73% by weight of the mercury. In comparison a NiS sorbent on a ceramic support (with a Ni content ca 24% wt as NiO) removed only 47% wt. The 1^{st} order rate constants were determined to be 0.040 s⁻¹ for the mixed valency sorbent and 0.020 s⁻¹ for the single-valency NiS. Examples 3a and 3b were tested in flowing tests according to the method of Example 2. Example 3a was tested: Initially the standard LHSV of 7 h⁻¹ was employed but Hg slip exit the bed was observed so the LHSV was reduced to 4 h⁻¹ and then 3 h⁻¹. This reduced the slip to zero. The material was run for 761 hours. The cumulative mercury content of the bed was 94.27 mg.

Example 3b was tested: Initially the standard LHSV of 7 h⁻¹ was employed but Hg slip exit the bed was observed so the LHSV was reduced to 5 h⁻¹ and then 3 h⁻¹. This reduced the slip to single-figure ppb levels. The material was run for 807 hours. The cumulative mercury content of the bed was 97.23 mg.

In comparison, a commercially-available NiS sorbent material was also tested. Initially the standard LHSV of 7 h⁻¹ was employed but Hg slip exit the bed was observed so the LHSV was reduced to 4 h⁻¹ and then 3 h⁻¹. This reduced the slip to zero. The material was run for 407 hours at which point significant mercury slip was observed in the exit. The cumulative mercury content of the bed was 26.39 mg.

These results indicate that the mixed valency nickel sulphides were again more active in removing mercury than the single-valency NiS.

### EXAMPLE 4

### Nickel Sorbents, Optimisation of Sulphidinq Process

A commercially available nickel oxide 12.4% Ni (as NiO) on a 2.5 mm trilobe alumina support was used as sorbent precursor. Two general sulphiding strategies were employed:

I) With a distinct pre-reduction step before sulphiding, or

II) Without a distinct pre-reduction step (and using simultaneous reduction and sulphidation)

I) With Pre-Reduction

The pre-reduction method involved heating the material to 400° C. in 100% vol H₂ and holding at that temperature for 4 hours. The material was then cooled (if necessary) to the sulphiding temperature and the gas was switched to 1% vol H₂S in nitrogen. The sample was then sulphided to saturation at a) 110° C., b) 250° C. and c) 400° C.

II) Without Pre-Reduction

Three methods without pre-reduction were employed:
a) Start with all gases on from cold and heat to 400° C. Sulphide to saturation at 400° C.
   Three gas stream mixtures were used;
   1% vol H₂S in pure hydrogen
   1% vol H₂S in a 50:50 vol mixture of H₂ and N₂
   1% vol H₂S in a 4:96 vol mixture of H₂ and N₂
b) Heat in H₂/N₂ to 400° C. then bring on 1% vol H₂S. Sulphide to saturation at 400° C. Four gas mixtures were used: 100% H₂, 50% H₂ in N₂, 10% H₂ in N₂, and 4% H₂ in N₂.
c) Heat in N₂ to 400° C. then bring on the H₂-containing gas and 1% vol H₂S. Sulphide to saturation at 400° C. Four gas mixtures were used: 100% H₂, 50% H₂ in N₂, 10% H₂ in N₂, and 4% H₂ in N₂.

The products were tested in the liquid phase static test according to the method of Example 1.

TABLE 7
With Pre-Reduction Results

| | Sulphiding | Crystalline Ni-S | | Liquid Phase Static |
|---|---|---|---|---|
| | Temperature | Phases Formed | S Content | Test Rate Constant, |
| Method | (° C.) | (XRD) | (% w/w) | k (s⁻¹) |
| 4(Ia) | 110 | none | 7.02 | 0.0201 |
| 4(Ib) | 250 | Ni₃S₄ | 8.48 | 0.0963 |
| 4(Ic) | 400 | NiS | 9.43 | 0.0862 |

These results demonstrate that to form the crystalline mixed-valency nickel sulphide, a sulphidation temperature between 110° C. and 400° C., preferably 200-300° C. is desired. The static test rate constants for the amorphous sulphur or single-valency NiS materials were lower than those for the mixed valency nickel sulphide sorbents.

TABLE 8
Without Pre-Reduction Results

| | | | | Liquid phase |
|---|---|---|---|---|
| | | Ni-S Phases Formed | S Content | Static Test Rate |
| Method | % H₂ | (XRD) | (% w/w) | Constant, k (s⁻¹) |
| 4(IIa) | 100 | Ni₇S₆ | 6.52 | — |
| 4(IIa) | 50 | Ni₇S₆ | 6.28 | — |
| 4(IIa) | 4 | Ni₇S₆ | 6.54 | 0.0488 |
| 4(IIb) | 100 | Ni₃S₄, Ni₇S₆ | 6.07 | — |
| 4(IIb) | 50 | Ni₇S₆ | 6.32 | — |
| 4(IIb) | 10 | Ni₃S₂, Ni₃S₄, Ni₇S₆ | 6.62 | 0.0118 |
| 4(IIb) | 4 | Ni₇S₆ | 6.64 | 0.0138 |
| 4(IIc) | 100 | Ni₃S₄ | 6.14 | 0.0108 |
| 4(IIc) | 50 | Ni₇S₆ | 5.95 | — |
| 4(IIc) | 10 | Ni₃S₄ | 4.20 | — |
| 4(IIc) | 4 | Ni₇S₆ | 6.79 | — |

The data shows that the method that includes a pre-reduction, gives a material with a higher rate constants for mercury removal. In particular, the method with sulphiding at 250° C. (example 4(1b)) gives the best results that have shown to be repeatable.

### EXAMPLE 5

### Nickel Sorbents, Investigation of Precursor (Route and Nickel Loading)

NiO on alumina materials were prepared using an impregnation method, employing a nickel nitrate solution, followed by calcination to generate NiO. Alumina trilobe and alumina sphere supports were used as support material.

TABLE 9

| Ref | Sorbent precursor description | % wt Ni (as NiO) |
|---|---|---|
| 5a | NiO from Ni nitrate on 2.5 mm alumina sphere | 12.4 |
| 5b | NiO from Ni nitrate on 2.5 mm alumina trilobe | 29.9 |

These materials were reduced at 400° C. and subsequently sulphided at 250° C. using the method of Example 4 (1(b)). The resulting sulphide materials were analysed for phases present (by XRD) and sulphur content (by LECO SOx infra-red analysis of combusted sample). They were also tested for mercury removal in the static test as described in Example 1. The results are shown below.

TABLE 10

| | | Sulphide | | Static test |
|---|---|---|---|---|
| Material | % wt Ni | phases | S Content | rate constant, |
| Ref. | (precursor) | formed | (% w/w) | k (s⁻¹) |
| 5a | 12.4 | Ni₃S₄ | 8.50 | 0.0963 |
| 5b | 29.9 | Ni₃S₄, Ni₃S₂ | 5.32 | 0.0399 |

The results show the reduced and passivated materials derived from Ni nitrate on alumina are effective for removing Hg.

### EXAMPLE 6

### Comparison of Ni Sorbent with Carbon

A static liquid phase test was performed to compare the sorbent of the present invention (Example 4(Ib)) with the typical sorbent used in reducing gas streams, activated carbon (Norit activated carbon RB3 grade).

The sorbent material (0.5 g) was added to a specific volume (60 ml) of n-hexane saturated with elemental mercury in a conical flask. This mixture was stirred at ambient temperature. Hexane samples were taken at 1, 2, 5, 10, 20, and 30 mins. These samples were then analysed for their mercury content using atomic fluorescence spectroscopy. The results were as follows;

TABLE 11

| | [Hg] of contacting solution (ppbv) | |
|---|---|---|
| Time (mins) | Carbon | Example 4(lb) |
| 0 | 1197 | 2289 |
| 1 | 1154 | 1903 |
| 2 | 1087 | 1705 |
| 4 | 1104 | 1376 |
| 7 | 1073 | 983 |
| 12 | 1052 | 578 |
| 20 | 962 | 302 |
| 30 | 918 | 121 |
| % removal at 30 mins | 23 | 95 |

The results clearly show the superior Hg sorbency of the materials of the present invention.

### EXAMPLE 7

### Gas Phase Testing

The nickel sulphide material of Example 4(1b) was tested for mercury removal in a reducing gas test.

A laboratory gas phase testing unit comprising a stainless steel tubular 1-inch internal diameter vessel and inlet and exit lines was used. The vessel and ancillary equipment were passivated to prevent mercury physisorption on the steel surfaces.

25 ml nickel sulphide sorbent was charged to the vessel, which is located in an oven so that it could be externally heated. Pure hydrogen was passed through the bed at 11.25 litres/hr at a pressure of 5 barg. The temperature of the bed was controlled to temperatures in the range 20 to 550° C. When the bed was at the desired temperature, the hydrogen gas stream was passed through a mercury bubbler to entrain mercury in the gas prior it being fed to the vessel. The mercury content of the gas was controlled in the range 30000 μg/m³ to 140000 μg/m³.

Tests were run for a range of times between 2 and 72 hours. The inlet and exit gases were analysed by atomic fluorescence spectroscopy for total mercury content. The results from the analysis at near the beginning, middle and end of each test are shown below. (ND=none detected).

Temperature=20° C.

| Time on Line | Inlet Result | Exit Result | |
|---|---|---|---|
| (mins) | (μg/m³) | (μg/m³) | % Removal |
| 19 | 124335 | 393 | 99.7 |
| 80 | 120488 | 713 | 99.4 |
| 140 | 120956 | ND | 100 |

Temperature=50° C.

| Time on Line | Inlet Result | Exit Result | |
|---|---|---|---|
| (mins) | (μg/m³) | (μg/m³) | % Removal |
| 17 | 138160 | ND | 100 |
| 78 | 138859 | ND | 100 |
| 138 | 137509 | ND | 100 |

Temperature=100° C.

| Time on Line | Inlet Result | Exit Result | |
|---|---|---|---|
| (mins) | (μg/m³) | (μg/m³) | % Removal |
| 19 | 129718 | ND | 100 |
| 503 | 132679 | 787 | 99.4 |
| 986 | 131425 | 227 | 99.8 |

Temperature=250° C.

| Time on Line | Inlet Result | Exit Result | |
|---|---|---|---|
| (mins) | (μg/m³) | (μg/m³) | % Removal |
| 52 | 120647 | 472 | 99.6 |
| 173 | 115762 | 1238 | 98.9 |
| 233 | 115757 | 1201 | 99.0 |

Temperature=350° C.

| Time on Line | Inlet Result | Exit Result | |
|---|---|---|---|
| (mins) | (μg/m³) | (μg/m³) | % Removal |
| 39 | 116909 | 2024 | 98.3 |
| 99 | 114205 | 2306 | 98.0 |
| 205 | 107332 | 2455 | 97.7 |

Temperature=400° C.

| Time on Line | Inlet Result | Exit Result | |
|---|---|---|---|
| (mins) | (μg/m³) | (μg/m³) | % Removal |
| 21 | 112754 | 1132 | 99.0 |
| 142 | 108820 | 1730 | 98.4 |
| 202 | 107096 | 1337 | 98.8 |

Temperature=450° C.

| Time on Line | Inlet Result | Exit Result | |
|---|---|---|---|
| (mins) | (μg/m³) | (μg/m³) | % Removal |
| 48 | 99628 | 2758 | 97.2 |
| 531 | 101959 | 2376 | 97.7 |
| 1076 | 103224 | 1981 | 98.1 |

Temperature=500° C.

| Time on Line | Inlet Result | Exit Result | |
|---|---|---|---|
| (mins) | (μg/m³) | (μg/m³) | % Removal |
| 12 | 69710 | 577 | 99.2 |
| 73 | 70221 | 790 | 98.9 |
| 133 | 69211 | 586 | 99.2 |

Temperature=550° C.

| Time on Line | Inlet Result | Exit Result | |
|---|---|---|---|
| (mins) | (μg/m³) | (μg/m³) | % Removal |
| 10 | 59199 | 1382 | 97.7 |
| 1038 | 74030 | ND | 100 |
| 1582 | 27683 | ND | 100 |
| 2126 | 72689 | ND | 100 |
| 2550 | 69761 | ND | 100 |
| 3094 | 71867 | ND | 100 |
| 3519 | 69496 | ND | 100 |
| 4305 | 79283 | ND | 100 |

These results indicate successful removal of the almost all the inlet Hg over the temperature range 20-550° C. for this material in a hydrogen gas stream. The extended test at 550° C. demonstrates the surprising stability of the Ni sorbent.

### EXAMPLE 8

### Long-Term Gas Phase Testing

The Ni₃S₄ nickel sulphide material of Example 4(Ib) was tested for mercury removal in a reducing gas test. The laboratory gas phase testing unit employed in Example 7 was used.

25 ml reduced and sulphided sorbent was charged to the reactor vessel. A gas blend of 80% (v/v) hydrogen and 20% (v/v) nitrogen was passed through the bed at 51 litres/hr at a pressure of 4.7 barg. The temperature of the bed was controlled at 50° C. When the bed was at the desired temperature, a portion (2 litres/hr) of the hydrogen/nitrogen gas stream was passed through a mercury bubbler to entrain mercury in the gas prior it being fed to the vessel. The mercury content of the gas was controlled at around 3000 μg/m³.

The test was run for 700 hours. Throughout the test the inlet and exit gases were analysed every hour by atomic fluorescence spectroscopy for total mercury content. The mercury concentration of the exit gas remained at zero for 700 hours at which point it increased to approximately 300 μg/m³ and the test was stopped.

At the end of the test, the absorbent bed was discharged as 8 discrete sub-bed layers, which were analysed for total mercury content by ICP-Optical Emission Spectroscopy. The limit of detection for this technique is 10 ppm (w/w). The results of this analysis are shown below.

| | Cumulative | Total Mercury |
|---|---|---|
| | Bed | Content |
| Bed # | Volume (ml) | (ppm w/w) |
| 1 (inlet) | 2.95 | 110 |
| 2 | 5.51 | 75 |
| 3 | 7.65 | 65 |
| 4 | 11.41 | 50 |
| 5 | 13.48 | 50 |
| 6 | 16.60 | 40 |
| 7 | 20.27 | 40 |
| 8 (exit) | 24.86 | 30 |

The results show a mercury profile down the bed with higher levels at the bed inlet.

### EXAMPLE 9

### Refinery-Gas Testing

The Ni₃S₄ nickel sulphide material of Example 4(Ib) was tested for mercury removal in a side-stream test at a refinery. The hydrocarbon gas tested contained a significant amount of hydrogen in addition to C1-C5 hydrocarbons, H₂S and CO₂.

The absorbent material was charged to a 1 litre, 64 mm ID stainless steel reactor. The reactor was connected to the refinery stream with a flow of 1.2 m³/hr passing over the test bed. The pressure of the system was 4.7 barg and the temperature varied between 35° C. and 80° C.

Regular samples of gas at the reactor inlet and exit were collected. This gas was analysed for mercury content using atomic fluorescence spectroscopy. The results of these analyses are given below.

| Time of | Mercury Content | |
|---|---|---|
| sample | (ng/Nm³) | |
| (hrs) | Inlet | Exit |
| 0.75 | 345 | 11 |
| 20 | 488 | 25 |
| 72 | 8930 | 9 |
| 94 | 175 | 26 |
| 143 | 527 | 30 |
| 166 | 1797 | 45 |
| 240 | 214 | 34 |
| 264 | 177 | 18 |
| 288 | 198 | 22 |
| 313 | 108 | 27 |
| 333 | 193 | 74 |
| 407 | 307 | 62 |
| 433 | 530 | 69 |
| 456 | 450 | 0 |
| 480 | 283 | 64 |
| 502 | 416 | 60 |
| 525 | 272 | 47 |
| 575 | 1110 | 45 |

The mercury results show a variation in mercury content of the stream between 108 and 8930 ng/Nm³. Throughout the test, the mercury removal by the absorbent material varied between 61 and 100% with an average removal rate of 88%.

Electrochemical hydrogen analysis on the inlet and exit gas streams showed no hydrogen consumption over the absorbent material, thus demonstrating its reduction resistance.

The test ran for 575 hours. At the end of the test, the absorbent bed was discharged as 10 discrete sub-beds, which were analysed for total mercury content by ICP-Optical Emission Spectroscopy. The limit of detection for this technique is 10 ppm (w/w). The average mercury content of the discharged 10 beds was 248 ppm (w/w).

1. A sorbent in the form of a shaped unit comprising one or more mixed-valency metal sulphides of vanadium, chromium, manganese, iron, cobalt or nickel.

2. A sorbent according to claim 1 wherein the mixed-valency metal sulphide is selected from the group consisting of Co₃S₄, Co₆S₅, Co₉S₈, V₅S₈, Ni₃S₄, Ni₇S₆ and Ni₃S₂.

3. A sorbent according to claim 1 wherein the mixed-valency metal sulphide comprises Ni₃S₂ or Ni₃S₄.

4. A sorbent according to claim 1 further comprising a binder.

5. A sorbent according to claim 4 wherein the binder is selected from the group consisting of clays, cements and a mixture thereof.

6. A sorbent according to claim 1 wherein the mixed valency metal sulphide is supported on a support material.

7. A sorbent according to claim 6 wherein the support material is selected from the group consisting of alumina, hydrated alumina, metal-aluminate, silica, titania, zirconia, zinc oxide, aluminosilicates, zeolites, metal carbonate, clay, cement, and carbon, and a mixture thereof.

8. A sorbent according to claim 1 wherein the shaped unit is a monolith, honeycomb or foam.

9. A sorbent according to claim 1 wherein the shaped unit is a pellet extrudate or granule.

10. A sorbent according to claim 9 wherein the shaped unit has a minimum dimension in the range 1 to 15 mm and a maximum dimension in the range 1 to 25 mm, with an aspect ratio (longest dimension divided by shortest dimension) ≦4.

11. A method for the production of a sorbent in the form of a shaped unit comprising one or more mixed-valency metal sulphides of vanadium, chromium, manganese, iron, cobalt or nickel, comprising the steps of:
(i) reducing a metal sulphide precursor compound of vanadium, chromium, manganese, iron, cobalt or nickel to a lower oxidation state with a hydrogen containing gas to form a reduced composition, and
(ii) simultaneously or sequentially sulphiding the reduced composition with a sulphiding compound to form the sorbent,
wherein the sorbent precursor or sorbent is shaped.

12. A method according to claim 11 wherein the metal sulphide precursor compound is selected from the group consisting of a soluble salt, an oxide, hydroxide, carbonate and hydroxycarbonate.

13. A method according to claim 11 further comprising a step of making the sorbent precursor by impregnating a support material with a solution of a soluble salt of vanadium, chromium, manganese, iron, cobalt or nickel, followed by drying and calcining the impregnated support.

14. A method according to claim 11 further comprising a step of making the sorbent precursor by mixing a metal sulphide precursor compound selected from an oxide, hydroxide, carbonate or hydroxycarbonate of vanadium, chromium, manganese, iron, cobalt or nickel, with one or more binders and optionally a support material.

15. A method according to claim 11 wherein the reduction stage is performed with a hydrogen containing gas at a temperature in the range 100-700° C.

16. A method according to claim 11 wherein the sulphiding compound comprises hydrogen sulphide.

17. A method according to claim 11 wherein the mixed valency sulphide is a nickel sulphide and the reduction step is carried out at a temperature in the range 350-450° C. and the sulphidation at temperature in the range 200-300° C.

18. A process for the removal of heavy metals, particularly mercury, from a fluid stream comprising hydrogen or carbon monoxide, by installing a sorbent according to claim 1 into a sorbent vessel and contacting the fluid stream with the sorbent.

19. A process according to claim 18 wherein the fluid stream is a liquid.

20. A process according to claim 19 wherein the liquid is a hydrogen-containing hydrocarbon stream fed to or recovered from a hydrotreating process.

21. A process according to claim 18 wherein the fluid stream is a reducing gas stream.

22. A process according to claim 21 wherein the reducing gas stream is contacted with the sorbent at a temperature up to 550° C.

23. A process according to claim 21 wherein the reducing gas stream is a synthesis gas stream.

24. A process according to claim 21 wherein the reducing gas stream is a refinery vent stream.

25. A process according to claim 21 wherein the reducing gas stream is a hydrogen-containing hydrocarbon stream fed to or recovered from a hydrotreating process.

26. A process according to claim 21 wherein the reducing gas stream is a crude synthesis gas stream from a gasifier.
